(19) United States
(12) Patent Application Publication
(10) Pub. No.: US 2008/0048833 A1
(43) Pub. Date: Feb. 28, 2008

(54) RFID READER SYSTEM AIDED BY RF POWER OF MEASUREMENT

(76) Inventor: Ronald A. Oliver, Seattle, WA (US)

Correspondence Address: MERCHANT & GOULD PC, P.O. BOX 2903, MINNEAPOLIS, MN, 55402-0903, US

(21) Appl. No.: 11/622,066

(22) Filed: Jan. 11, 2007

Related U.S. Application Data
(60) Provisional application No. 60/758,349, filed on Jan. 12, 2006.

(51) Int. Cl. H04B 7/00

(52) U.S. Cl. 340/10.3

(57) ABSTRACT

Methods and circuits for using measurement based threshold(s) to detect Radio Frequency IDentification (RID) tag responses in readers are described. Tag response itself is detected based on a measurement that is compared to a measurement during a tag silent period. Beginning and/or end of tag response are also detected using multiple measurements during tag response. The initial detection threshold may be replaced with a lower second threshold once demodulation of the tag response begins.

### RELATED APPLICATIONS

This utility patent application claims the benefit of U.S. Provisional Application Ser. No. 60/758,349 filed on Jan. 12, 2006, which is hereby claimed under 35 U.S.C. §119(e). The provisional application is incorporated herein by reference.

This application may be found to be related to the following application, which is incorporated herein by reference: Application titled “RFID SYSTEMS DETECTING PILOT TONE”, by inventors Christopher J. Diorio, Todd E. Humes, Scott A. Cooper, Kurt E. Sundstrom, Amir Sarajedini, Aanand Esterberg filed with the USPTO on the same day as the present application, and due to be assigned to the same assignee (Attorney Docket #pb 50133.52USUI/IMPJ-0179).

This application may also be found to be related to the following application, which is incorporated herein by reference: Application titled “RFID READER SYSTEMS WITH DIGITAL RATE CONVERSION”, by inventor Kurt E. Sundstrom filed with the USPTO on the same day as the present application, and due to be assigned to the same assignee (Attorney Docket #50133.61USUI/IMPJ-0198).

### BACKGROUND

Radio Frequency IDentification (RFID) systems typically include RFID tags and RFID readers (the latter are also known as RFID reader/writers or RFID interrogators). RFID systems can be used in many ways for locating and identifying objects to which the tags are attached. RFID systems are particularly useful in product-related and service-related industries for tracking large numbers of objects being processed, inventoried, or handled. In such cases, an RFID tag is usually attached to an individual item, or to its package.

In principle, RFID techniques entail using an RFID reader to interrogate one or more RFID tags. The reader transmitting a Radio Frequency (RF) wave performs the interrogation. A tag that senses the interrogating RF wave responds by transmitting back another RF wave. The tag generates the transmitted back RF wave either originally, or by reflecting back a portion of the interrogating RF wave in a process known as backscatter. Backscatter may take place in a number of ways.

The reflected-back RF wave may further encode data stored internally in the tag, such as a number. The response is demodulated and decoded by the reader, which thereby identifies, counts, or otherwise interacts with the associated item. The decoded data can denote a serial number, a price, a date, a destination, other attribute(s), any combination of attributes, and so on.

An RFID tag typically includes an antenna system, a power management section, a radio section, and frequently a logical section, a memory, or both. In earlier RFID tags, the power management section included an energy storage device, such as a battery. RFID tags with an energy storage device are known as active tags. Advances in semiconductor technology have miniaturized the electronics so much that an RFID tag can be powered solely by the RF signal it receives. Such RFID tags do not include an energy storage device, and are called passive tags.

Tags may respond to a reader command after an initial silent period, but typically an exact time of tag response is not known by the reader ahead of time. To complicate the operation further, interference from noise sources in the environment may mask tag response(s), or be mistaken by the reader as a true tag response.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments are directed to detecting RFID tag responses in an RFID reader. The tag response may be detected based on a measurement during a tag silent period and a subsequent one during the tag response. Beginning or end of tag response may also be detected using multiple measurements during tag response. Other embodiments employ a second threshold set after the beginning of tag response demodulation to accommodate lower tag power or higher noise levels.

### BRIEF DESCRIPTION OF THE DRAWINGS

Non-limiting and non-exhaustive embodiments are described with reference to the following drawings.

FIG. 1 is a diagram of an example RFID system including an RFID reader communicating with an RFID tag in its field of view;

FIG. 2 is a diagram for explaining a half-duplex mode of communication between the components of the RFID system of FIG. 1;

FIG. 3 is a block diagram of a whole RFID reader system according to embodiments;

FIG. 4 is a block diagram illustrating an overall architecture of a RFID reader system according to embodiments;

FIG. 5 is a flowchart of an RFID reader process for using power measurement(s) in performing demodulation actions responsive to received signals according to embodiments;

FIG. 6A shows examples of RFID tag response to a received reader command along a timeline;

FIG. 6B shows examples of possible power measurements according to embodiments within the tag response timeline diagram of FIG. 6A;

FIG. 7A is a diagram illustrating use of power measurements in tag silent periods to set RFID tag detection threshold according to embodiments;

FIG. 7B is another diagram illustrating use of power measurements in tag silent periods to set and optionally verify RFID tag detection threshold according to embodiments;

FIG. 8A is a diagram illustrating how a start of a tag response may be detected using multiple power measurements according to embodiments;

FIG. 8B is another diagram illustrating use of multiple power measurements to confirm the start of backscattered data according to embodiments;

FIG. 9A is a diagram illustrating how an end of a tag response may be detected using multiple power measurements according to embodiments;

FIG. 9B is another diagram illustrating use of multiple power measurements to confirm the end of backscattered data according to embodiments;

FIG. 9C is a further diagram illustrating use of multiple power measurements to confirm the end of backscattered data according to embodiments;

FIG. 10A is a diagram illustrating use of two thresholds based on demodulation according to embodiments;

FIG. 10B is another diagram illustrating use of two thresholds in detecting tag response based on demodulation according to embodiments;

FIG. 11A illustrates waveforms representing versions of tag signals in detecting a tag pilot tone using a noise-based threshold

FIG. 11B illustrates detection of a tag pilot tone using two criteria according to embodiments; and

FIG. 12 is a block diagram for an embodiment of a pilot tone detection circuit where the waveforms of FIG. 11A may be observed.

### DETAILED DESCRIPTION

Various embodiments will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed subject matter.

Throughout the specification and claims, the following terms take at least the meanings explicitly associated herein, unless the context clearly dictates otherwise. The meanings identified below are not intended to limit the terms, but merely provide illustrative examples for the terms. The meaning of “a,” “an,” and “the” includes plural reference, the meaning of “in” includes “in” and “on.” The term “connected” means a direct electrical connection between the items connected, without any intermediate devices. The term “coupled” means either a direct electrical connection between the items connected or an indirect connection through one or more passive or active intermediary devices. The term “circuit” means either a single component or a multiplicity of components, either active and/or passive, that are coupled together to provide a desired function. The term “signal” means at least one current, voltage, charge, temperature, data, or other measurable quantity. The terms “RFID reader” and “RFID tag” are used interchangeably with the terms “reader” and “tag”, respectively, throughout the text and claims.

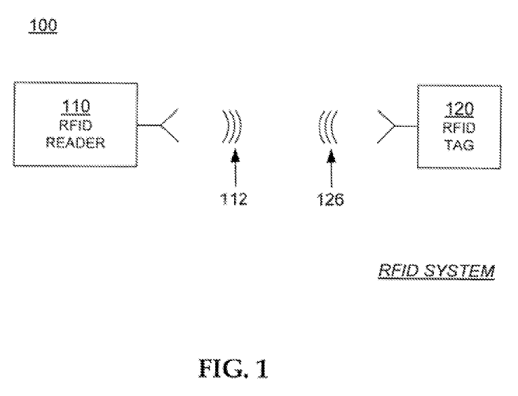

FIG. 1 is a diagram of components of a typical RFID system 100, incorporating aspects of the invention. An RFID reader 110 transmits an interrogating Radio Frequency (FR) wave 112. RFID tag 120 in the vicinity of RFID reader 110 may sense interrogating RF wave 112, and generate wave 126 in response. RFID reader 110 senses and interprets wave 126.

Reader 110 and tag 120 exchange data via wave 112 and wave 126. In a session of such an exchange, each encodes, modulates, and transmits data to the other, and each receives, demodulates, and decodes data from the other. The data is modulated onto, and decoded from, RF waveforms.

Encoding the data in waveforms can be performed in a number of different ways. For example, protocols are devised to communicate in terms of symbols, also called RFID symbols. A symbol for communicating can be a delimiter, a calibration symbol, and so on. Further symbols can be implemented for ultimately exchanging binary data, such as “0” and “1”, if that is desired. In turn, when the waveforms are processed internally by reader 110 and tag 120, they can be equivalently considered and treated as numbers having corresponding values, and so on.

Tag 120 can be a passive tag or an active tag, i.e. having its own power source. Where tag 120 is a passive tag, it is powered from wave 112.

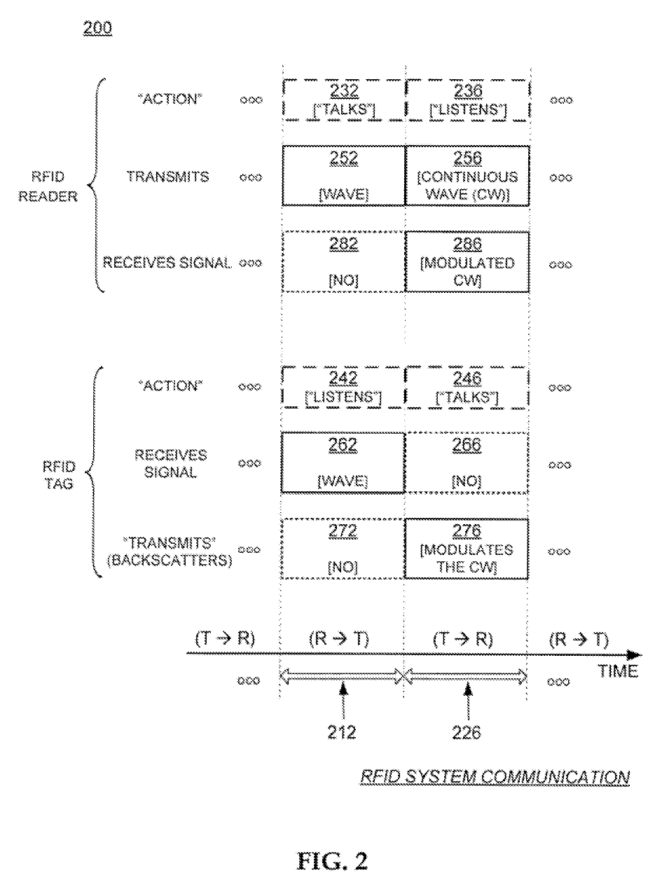

FIG. 2 is a diagram 200 for explaining the half-duplex mode of communication between the components of the RFID system of FIG. 1, especially when tag 120 is implemented as a passive tag. The explanation is made with reference to a TIME axis, and also to a human metaphor of “talking” and “listening”. The actual technical implementations for “talking” and “listening” are now described.

RFID reader 110 and RFID tag 120 talk and listen to each other by taking turns. As seen on axis TIME, when reader 110 talks to tag 120 the communication session is designated as “R→T”, and when tag 120 talks to reader 110 the communication session is designated as “T→R”. Along the TIME axis, a sample R→T communication session occurs during a time interval 212, and a following sample T→R communication session occurs during a time interval 226. Of course interval 212 is typically of a different duration than interval 226—here the durations are shown approximately equal only for purpose of illustration.

According to blocks 232 and 236, RFID reader 110 talks during interval 212, and listens during interval 226. According to blocks 242 and 246, RFID tag 120 listens while reader 110 talks (during interval 212), and talks while reader 110 listens (during interval 226).

In terms of actual technical behavior, during interval 212, reader 110 talks to tag 120 as follows. According to block 252, reader 110 transmits wave 112, which was first described in FIG. 1. At the same time, according to block 262, tag 120 receives wave 112 and processes it, to extract data and so on. Meanwhile, according to block 272, tag 120 does not backscatter with its antenna, and according to block 282, reader 110 has no wave to receive from tag 120.

During interval 226, tag 120 talks to reader 110 as follows. According to block 256, reader 110 transmits a Continuous Wave (CW), which can be thought of as a carrier signal that ideally encodes no information. As discussed before, this carrier signal serves both to be harvested by tag 120 for its own internal power needs, and also as a wave that tag 120 can backscatter. Indeed, during interval 226, according to block 266, tag 120 does not receive a signal for processing. Instead, according to block 276, tag 120 modulates the CW emitted according to block 256, so as to generate backscatter wave 126. Concurrently, according to block 286, reader 110 receives backscatter wave 126 and processes it.

In the above, an RFID reader/interrogator may communicate with one or more RFID tags in any number of ways. Some such ways are called protocols. A protocol is a specification that calls for specific manners of signaling between the reader and the tags.

One such protocol is called the Specification for RFID Air Interface—EPC (TM) Radio-Frequency Identity Protocols Class-1 Generation-2 UHF RFID Protocol for Communications at 860 MHz-960 MHz, which is also colloquially known as “the Gen2 Spec”. The Gen2 Spec has been ratified by EPCglobal, which is an organization that maintains a website at: <http://www.epcglobalinc.or/> at the time this document is initially filed with the USPTO.

It was described above how reader 110 and tag 120 communicate in terms of time. In addition, communications between reader 110 and tag 120 may be restricted according to frequency. One such restriction is that the available frequency spectrum may be partitioned into divisions that are called channels. Different partitioning manners may be specified by different regulatory jurisdictions and authorities (e.g. FCC in North America, CEPT in Europe, etc.).

The reader 110 typically transmits with a transmission spectrum that lies within one channel. In some regulatory jurisdictions the authorities permit aggregating multiple channels into one or more larger channels, but for all practical purposes an aggregate channel can again be considered a single, albeit larger, individual channel.

Tag 120 can respond with a backscatter that is modulated directly onto the frequency of the reader's emitted CW, also called baseband backscatter. Alternatively, Tag 120 can respond with a backscatter that is modulated onto a frequency, developed by Tag 120, that is different from the reader's emitted CW, and this modulated tag frequency is then impressed upon the reader's emitted CW. This second type of backscatter is called subcarrier backscatter. The subcarrier frequency can be within the reader's channel, can straddle the boundaries with the adjacent channel, or can be wholly outside the reader's channel.

A number of jurisdictions require a reader to hop to a new channel on a regular basis. When a reader hops to a new channel it may encounter RF energy there that could interfere with communications.

Embodiments of the present disclosure can be useful in different RFID environments, for example, in the deployment of RFID readers in sparse- or dense-reader environments, in environments with networked and disconnected readers such as where a hand-held reader may enter the field of networked readers, in environments with mobile readers, or in environments with other interference sources. It will be understood that the present embodiments are not limited to operation in the above environments, but may provide improved operation in such environments.

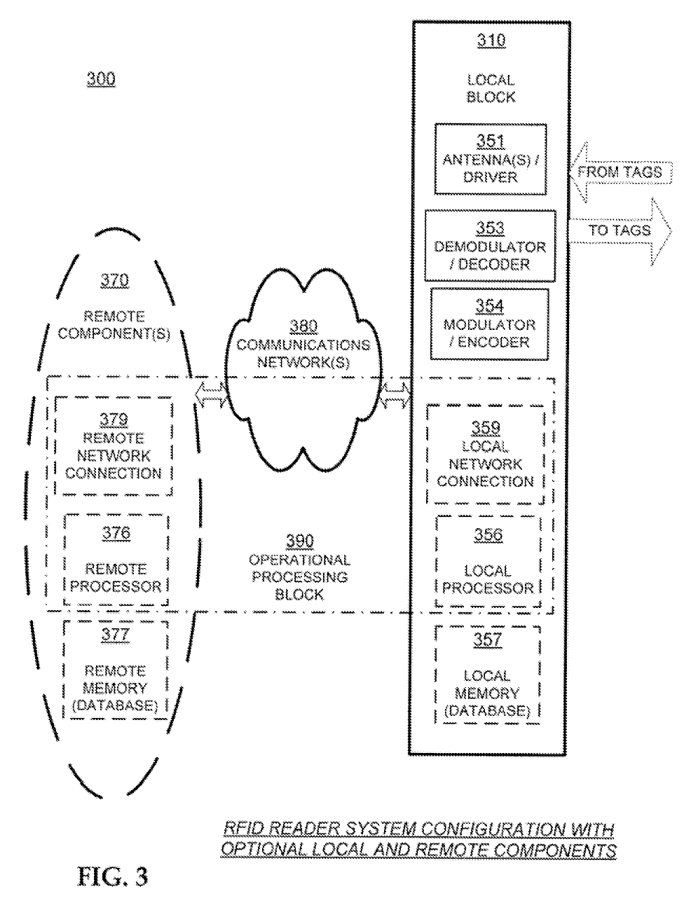

FIG. 3 is a block diagram of a whole RFID reader system 300 according to embodiments. System 300 includes a local block 310, and optionally remote components 370. Local block 310 and remote components 370 can be implemented in any number of ways. It will be recognized that reader 110 of FIG. 1 is the same as local block 310, if remote components 370 are not provided. Alternately, reader 110 can be implemented instead by system 300, of which only the local block 310 is shown in FIG. 1.

Local block 310 is responsible for communicating with the tags. Local block 310 includes a block 351 of an antenna and a driver of the antenna for communicating with the tags. Some readers, like that shown in local block 310, contain a single antenna and driver. Some readers contain multiple antennas and drivers and a method to switch signals among them, including sometimes using different antennas for transmitting and for receiving. And some readers contain multiple antennas and drivers that can operate simultaneously. A demodulator/decoder block 353 demodulates and decodes backscattered waves received from the tags via antenna block 351. Modulator/encoder block 354 encodes and modulates an RF wave that is to be transmitted to the tags via antenna block 351.

Local block 310 additionally includes an optional local processor 356. Processor 356 may be implemented in any number of ways known in the art. Such ways include, by way of examples and not of limitation, digital and/or analog processors such as microprocessors and digital-signal processors (DSPs); controllers such as microcontrollers; software running in a machine such as a general purpose computer; programmable circuits such as Field Programmable Gate Arrays (FPGAs), Field-Programmable Analog Arrays (FPAAs), Programmable Logic Devices (PLDs), Application Specific Integrated Circuits (ASIC), any combination of one or more of these; and so on. In some cases some or all of the decoding function in block 353, the encoding function in block 354, or both, may be performed instead by processor 356.

Local block 310 additionally includes an optional local memory 357. Memory 357 may be implemented in any number of ways known in the art. Such ways include, by way of examples and not of limitation, nonvolatile memories (NVM), read-only memories (ROM), random access memories (RAM), any combination of one or more of these, and so on. Memory 357, if provided, can include programs for processor 356 to run, if provided.

In some embodiments, memory 357 stores data read from tags, or data to be written to tags, such as Electronic Product Codes (EPCs), Tag Identifiers (TIDs) and other data. Memory 357 can also include reference data that is to be compared to the EPC codes, instructions and/or rules for how to encode commands for the tags, modes for controlling antenna 351, and so on. In some of these embodiments, local memory 357 is provided as a database.

Some components of local block 310 typically treat the data as analog, such as the antenna/driver block 351. Other components such as memory 357 typically treat the data as digital. At some point there is a conversion between analog and digital. Based on where this conversion occurs, a whole reader may be characterized as “analog” or “digital”, but most readers contain a mix of analog and digital functionality.

If remote components 370 are indeed provided, they are coupled to local block 310 via an electronic communications network 380. Network 380 can be a Local Area Network (LAN), a Metropolitan Area Network (MAN), a Wide Area Network (WAN), a network of networks such as the internet, and so on. In turn, local block 310 then includes a local network connection 359 for communicating with network 380.

There can be one or more remote component(s) 370. If more than one, they can be located at the same place with each other, or in different places. They can access each other and local block 310 via network 380, or via other similar networks, and so on. Accordingly, remote component(s) 370 can use respective remote network connections. Only one such remote network connection 379 is shown, which is similar to local network connection 359, etc.

Remote component(s) 370 can also include a remote processor 376. Processor 376 can be made in any way known in the art, such as was described with reference to local processor 356.

Remote component(s) 370 can also include a remote memory 377. Memory 377 can be made in any way known in the art, such as was described with reference to local memory 357. Memory 377 may include a local database, and a different database of a Standards Organization, such as one that can reference EPCs.

Of the above-described elements, it is advantageous to consider a combination of these components, designated as operational processing block 390. Block 390 includes those that are provided of the following: local processor 356, remote processor 376, local network connection 359, remote network connection 379, and by extension an applicable portion of network 380 that links connection 359 with connection 379. The portion can be dynamically changeable, etc. In addition, block 390 can receive and decode RF waves received via antenna 351, and cause antenna 351 to transmit RF waves according to what it has processed.

Block 390 includes either local processor 356, or remote processor 376, or both. If both are provided, remote processor 376 can be made such that it operates in a way complementary with that of local processor 356. In fact, the two can cooperate. It will be appreciated that block 390, as defined this way, is in communication with both local memory 357 and remote memory 377, if both are present.

Accordingly, block 390 is location agnostic, in that its functions can be implemented either by local processor 356, or by remote processor 376, or by a combination of both. Some of these functions are preferably implemented by local processor 356, and some by remote processor 376. Block 390 accesses local memory 357, or remote memory 377, or both for storing and/or retrieving data.

Reader system 300 operates by block 390 generating communications for RFID tags. These communications are ultimately transmitted by antenna block 351, with modulator/encoder block 354 encoding and modulating the information on an RF wave. Then data is received from the tags via antenna block 351, demodulated and decoded by demodulator/decoder block 353, and processed by processing block 390.

The invention additionally includes programs, and methods of operation of the programs. A program is generally defined as a group of steps or operations leading to a desired result, due to the nature of the elements in the steps and their sequence. A program is usually advantageously implemented as a sequence of steps or operations for a processor, such as the structures described above.

Performing the steps, instructions, or operations of a program required manipulation of physical quantities. Usually, though not necessarily, these quantities may be transferred, combined, compared, and otherwise manipulated or processed according to the steps or instructions, and they may also be stored in a computer-readable medium. These quantities include, for example, electrical magnetic, and electromagnetic charges or particles, states of matter, and in the more general case can include the states of any physical devices or elements. It is convenient at times, principally for reasons of common usage, to refer to information represented by the states of these quantities as bits, data bits, samples, values, symbols, characters, terms, numbers, or the like. It should be borne in mind, however, that all of these and similar terms are associated with the appropriate physical quantities, and that these terms are merely convenient labels applied to these physical quantities, individually or in groups.

The invention furthermore includes storage media. Such media, individually or in combination with others, have stored thereon instructions of a program made according to the invention. A storage medium according to the invention is a computer-readable medium, such as a memory, and its read by a processor of the type mentioned above. If a memory, it can be implemented in a number of ways, such as Read Only Memory (ROM), Random Access Memory (RAM), etc., some of which are volatile and some non-volatile.

Even though it is said that the program may be stored in a computer-readable medium, it should be clear to a person skilled in the art that it need not be a single memory, or even a single machine. Various portions, modules or features of it may reside in separate memories, or even separate machines. The separate machines may be connected directly, or through a network such as a local access network (LAN) or a global network such as the Internet.

Often, for the sake of convenience only, it is desirable to implement and describe a program as software. The software can be unitary, or thought in terms of various interconnected distinct software modules.

This detailed description is presented largely in terms of flowcharts, algorithms, and symbolic representations of operations on data bits on and/or within at least one medium that allows computational operations, such as a computer with memory. Indeed, such descriptions and representations are the type of convenient labels used by those skilled in programming and/or the data processing arts to effectively convey the substance of their work to others skilled in the art. A person skilled in the art of programming may use these descriptions to readily generate specific instructions for implementing a program according to the present invention.

Embodiments of an RFID reader system can be implemented as a combination of hardware and software. It is advantageous to consider such a system as subdivided into components or modules. A person skilled in the art will recognize that some of these components or modules can be implemented as hardware, some as software, some as firmware, and some as a combination. An example of such a subdivision is now described.

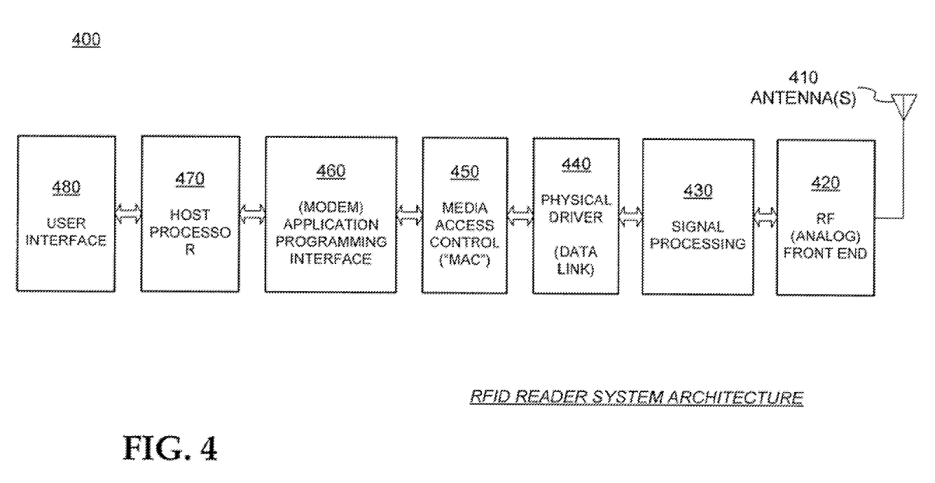

FIG. 4 is a block diagram illustrating an overall architecture of a RFID reader system 400 according to embodiments. It will be appreciated that system 400 is considered subdivided into modules or components. Each of these modules may be implemented by itself, or in combination with others. It will be recognized that some aspects are parallel with those of FIG. 3. In addition, some of them may be present more than once.

RFID reader system 400 includes one or more antennas 410, and an RF Front End 420, for interfacing with antenna(s) 410. These can be made as described above. In addition, Front End 420 typically includes analog components.

System 400 also includes a Signal Processing module 430. In this embodiment, module 430 exchanges waveforms with Front End 420, such as I and Q waveform pairs. In some embodiments, signal processing module 430 is implemented by itself in an FPGA.

System 400 also includes a Physical Driver module 440, which is also known as Data Link. In this embodiment, module 440 exchanges bits with module 430. Data Link 440 can be the stage associated with framing of data. In one embodiment, module 440 is implemented by a Digital Signal Processor.

System 400 additionally includes a Media Access Control module 450, which is also known as MAC layer. In this embodiment, module 450 exchanges packets of bits with module 440. MAC layer 450 can be the stage for making decisions for sharing the medium of wireless communication, which in this case is the air interface. Sharing can be between reader system 400 and tags, or between system 400 with another reader, or between tags, or a combination. In one embodiment, module 450 is implemented by a Digital Signal Processor.

System 400 moreover includes an Application Programming Interface module 460, which is also known as API, Modem API, and MAPI. In some embodiments, module 460 is itself an interface for a user.

System 400 further includes a host processor 470. Processor 470 exchanges signals with MAC layer 450 via module 460. In come embodiments, host processor 470 is not considered as a separate module, but one that includes some of the above-mentioned modules of system 400. A user interface 480 is coupled to processor 470, and it can be manual, automatic, or both.

Host processor 470 can include applications for system 400. In some embodiments, elements of module 460 may be distributed between processor 470 and MAC layer 450.

It will be observed that the modules of system 400 forms something of a chain. Adjacent modules in the chain can be coupled by the appropriate instrumentalities for exchanging signals. These instrumentalities include conductors, buses, interfaces, and so on. These instrumentalities can be local, e.g. to connect modules that are physically close to each other, or over a network, for remote communication.

The chain is used in oppopsite directions for receiving and transmitting. In a receiving mode, wireless waves are received by antenna(s) 410 as signals, which are in turn processed successively by the various modules in the chain. Processing can terminate in any one of the modules. In a transmitting mode, initiation can be in any one of these modules. That, which is to be transmitted becomes ultimately signals for antenna(s) 410 to transmit as wireless waves.

The architecture of system 400 is presented for purposes of explanation, and not of limitation. Its particular subdivision into modules need not be followed for creating embodiments according to the invention. Furthermore, the features of the invention can be performed either within a single one of the modules, or by a combination of them.

An economy is achieved in the present document in that a single set of flowcharts is used to describe methods in and of themselves, along with operations of hardware and/or software. This is regardless of how each element is implemented.

The invention also includes methods. Some are methods of operation of an RFID reader or RFID reader system. Others are methods for controlling an RFID reader or RFID reader system.

These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

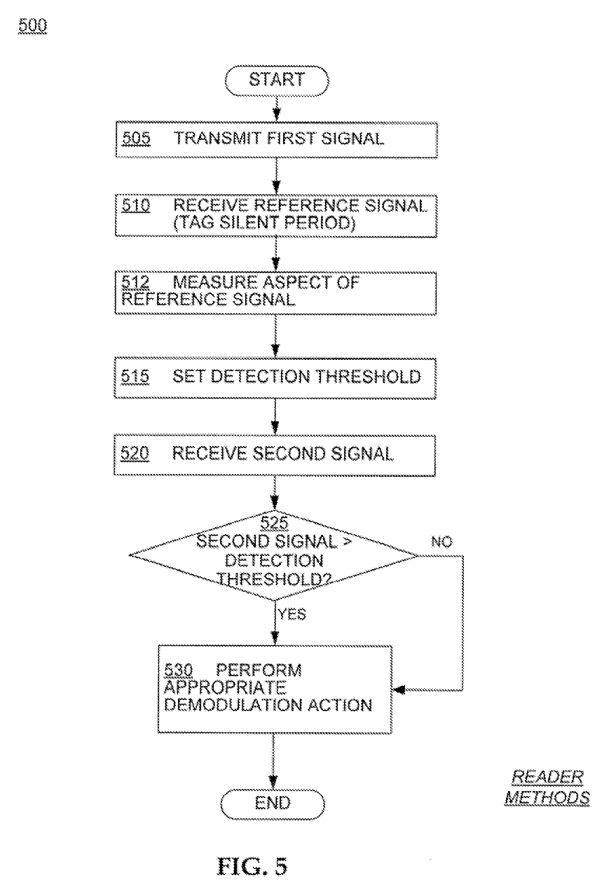

FIG. 5 is a flowchart of an RFID reader process for using power measurement(s) in demodulating a signal from a tag according to embodiments.

Process 500 begins at operation 505, where a first signal is transmitted by the RFID reader. The first signal may be an unmodulated carrier wave, a modulated carrier wave, and the like. The signal is transmitted, as caused by the appropriate component.

Typically such a signal encodes a command for the RFID tags, to respond in a certain manner. The command would be according to the Air Interface communication protocol, which further specifies when the RFID tags are to respond, and which is known in advance to the reader system.

In some embodiments, the first signal causes the RFID tags to be silent during a tag silent period, during which they do not backscatter any signal upon receiving the first signal from the reader. The tag silent period can be before the tags are to backscatter, or after they have completed communicating back, or both.

According to a next operation 510, a reference signal is received by the reader during the first silent period of the tag. According to some embodiments, the reference signal maybe a background noise detected by the reader while the tags are silent.

According to a next operation 512, an aspect of the reference signal can be measured. Any aspect can be measured, such as a power, a voltage a current, and so on. The aspect is measured from a single measurement or many, or a continuing one integrating over some time.

While operations 510 and 512 can be performed only once, it is advantageous that they be performed more frequently. For example, they can be performed every time a command is transmitted, as per operation 505.

An advantage, therefore, is that the measured reference signal reflects the ambient noise, free from any backscatter of the RFID tags of interest. In some embodiments, the ambient noise can be too high, and other measures can be implemented. For example, if the measured aspect exceeds a threshold, a data rate of a transmit circuit of the RFID system can be adjusted down. Or the RFID tags can be commanded to not respond on the baseband frequency of the first signal, but on its subcarrier. Inverse measures can be implemented if the ambient noise is lower than expected.

According to a next operation 515, a detection threshold is set from the measured aspect. The detection threshold can be set in any number of ways, such as by adjusting a filter in a receive circuit of the RFID reader system. As such, the detection threshold can be determined as a quantity expressed in one of: dB, Watts, Volts, Amps, a number, and so on.

An advantage, therefore, is that the detection threshold is set at a time that it is known that the tags are not backscattering, because they have been forced to be silent from the reader. This will enable more reliable measurements later on.

According to a next operation 520, a second signal is received by the reader. The second signal may include a response transmission from any one of the tags within field of view or an interference signal. Plus, it will be understood that the second signal can occur before or after the initial reference signal, and before or after later mentioned third signals. In a number of embodiments, the first signal further causes at least one of the RFID tags to start responding within a known response window, and the second signal is received within the known response window.

A power of the second signal is measured, e.g. by one or many measurements, such as the above. Instead of the power, another aspect of the second signal can be equivalently measured. And the measured aspect can be expressed or coverted to the same units as the detection threshold, for the impending comparison with the detection threshold to make sense. Of all possible aspects, power is mentioned more predominantly in this document, because it is the preferred signal aspect to measure.

According to a next decision operation 525, a power or other aspect of the second signal and of the detection threshold are compared. In many embodiments the comparison effectively reveals the presence or absence of a detected backscattered tag signal, as contrasted to the background ambient noise.

According to a next operation 530, an appropriate demodulation action is performed on the second signal. The comparison can decide which is demodulation action is appropriate. Demodulation action for purposes of this document can mean a number of possibilities.

In some embodiments, the comparison can reveal that the RFID signal has recently started, or what is being received has recently become valid tag backscatter. These are particularly useful where, as will be seen below, it is unknown, when the RFID backscatter will start, with uncertainty over a large window. Such happens, for example, after a WRITE command has been transmitted with the first signal.

In these embodiments, the demodulation action can include to start demodulating the second signal. Or the second signal can be stored, and the demodulation action includes demodulating and start accepting it instead of discarding it.

These can be distinguished from other signals that can be received before the second signal, which have a power less than the detection threshold. Such other signals can be discarded. They can be tentatively stored before it is decided to discard them. They could even be demodulated, and then discarded.

In some embodiments, it is thus established that the second signal is from an RFID tag. Then the detection threshold can be set to an updated value, which corresponds to receiving tag data. As long as the second signal is continuing being above the updated threshold, it can be demodulated and accepted.

When, however, third signals are received after the second signal, which have a power less than the updated detection threshold, they can be rejected, as the tag no longer backscatters. Then optionally the detection threshold can be reset to its previous value.

The results can also be checked in other ways. For example, a second measurement of the ambient noise can be performed without the tags, after the reader has transmitted another command, which has caused another silent period and so on. If the second measurement of the ambient noise is now higher than even the detection threshold, then the demodulation action can includes discarding the second signal.

Of course, the received second signals can be checked by other criteria. For example, it can be demodulated anyway, and then be given a demodulation score. If this score is higher than a threshold, it can be accepted. Such techniques can also be used very well to determine what should be the demodulation action.

In other embodiments, the comparison of the second signal to the initially set detection threshold can reveal that the RFID signal has recently ended, or what is being received is as of recently no longer valid tag backscatter. These are particularly useful where, as will be seen below, it is unknown when the RFID backscatter will end. Such happens, for example, where command that has been transmitted with the first signal causes the tag to backscatter what is in its memory, but the reader does not know in advance how long that will take.

In these embodiments, the demodulation action can include discarding or starting discarding the second signal, instead of demodulating and accepting it. In some embodiments the second signal could be stored prior to being discarded. It could even be demodulated, but then discarded without being accepted. This way the second signal is distinguished from other, third signals that can be received prior to the second signal. Such third signals can have a power greater than the detection threshold, and be demodulated and accepted.

These third signals can be portions of a response from one of the RFID tags. As such, a duration of the tag response can be determined based on the timing of the second signal. A power of the third signals can be measured according to a timing of the portions, for better results.

Moreover, the tag response can be decoded, after the third signals are demodulated. An expected length of the tag response can be determined from the decoded tag response. Then an expected duration of the tag response can be determined from the expected length. If the determined duration is inconsistent with the expected duration, the whole tag response can be discarded.

Examples are now described in more detail.

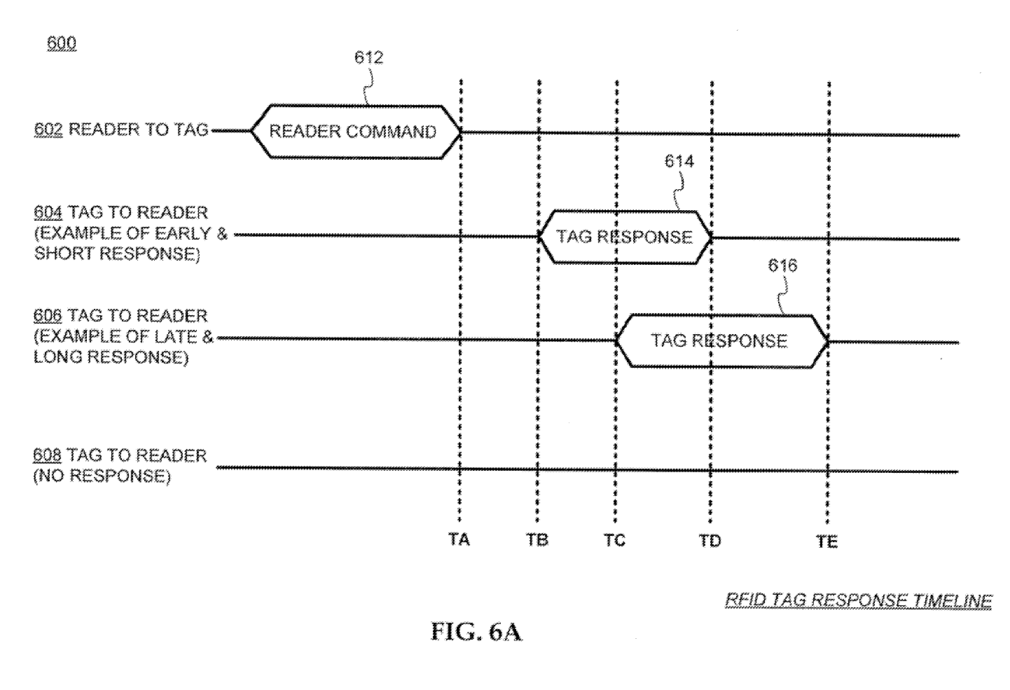

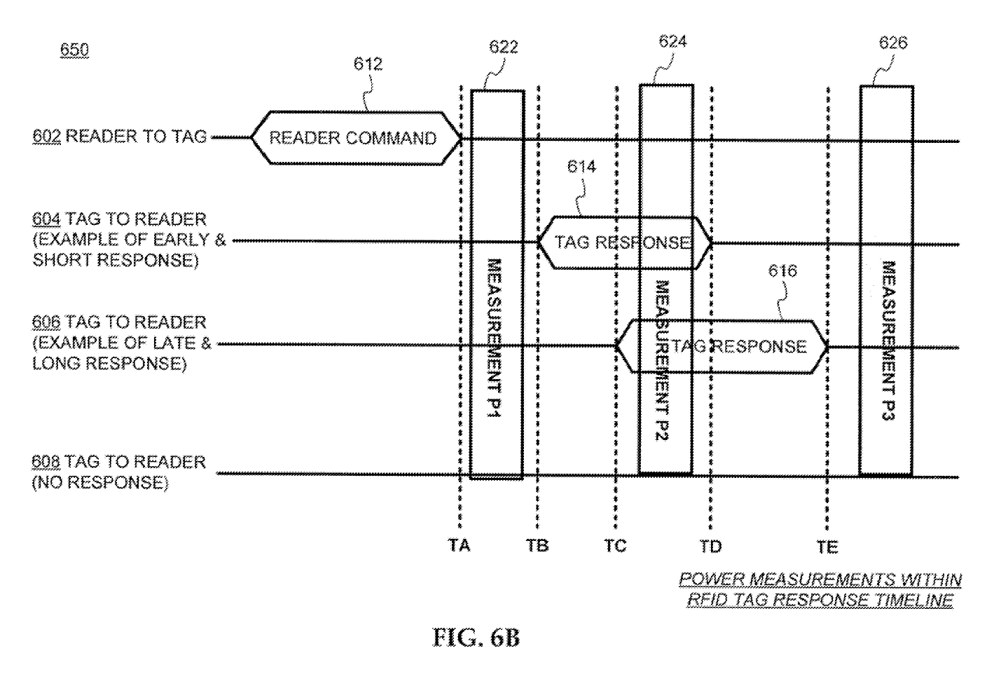

FIG. 6A shows examples of RFID tag response to a received reader command along a timeline. As illustrated, communication between the reader and a tag begins with reader to tag transmission (602) which is initiated by the transmission of a first signal that encodes reader command 612. The transmission of the reader command 612 ends at time point TA.

One or more of the RFID tags responds to reader command 612, by backscattering as per the above. The response is perceived and detected by the reader as a signal. The challenge is for the reader to discern which signals are from the tags, and which from the environment.

In the Gen2 Spec it is specified that, after a time TA, there shall be a tag silent period during which no tag may respond. Then responses may start, shortly thereafter, or later, depending on a number of factors, such as which command 612 was sent, and so on. The tag silent period is shown in the figure as the time between time points TA and TB.

Tags within the field of view of the reader may respond at different times due to various reasons. An example of an early tag response 614 is shown along the timeline tag to reader 604 between the time points TB and TD.

Tag respond 616 is an example of a later response along the timeline tag to reader 606. The later tag response 616 begins after the early tag response 614 at time point TC and ends at time point TE.

Tag responses may also vary in their length (duration). Tag response 616 is an example of a long tag response as illustrated by the distance between time points TC and TE, while tag response 614 is an example of a short tag response as illustrated by the distance between time points TB and TD.

FIG. 6B shows examples of possible power measurements according to embodiments within the tag response timeline diagram of FIG. 6A.

In diagram 650, three possible measurements are illustrated. The first measurement P1 (622) is made during the silent period between time points TA and TB following the transmission of reader command 612. As per the above, measurement P1 is done with the confidence that no tag responses are included, such as tag responses 614 and 616.

The second power measurement P2 (624) may be performed at any time during the tags' responses, for example between time periods TC and TD where both tags' responses may be detected.

Finally, a third power measurement P3 (626) may be made in the silent period after TE when all tag responses are expected to be completed. Again, measurement P3 is done with the confidence that no tag responses are included, such as tag responses 614 and 616.

It should be noted that these power measurements are illustrative of different power measurements that may be made during reader-tag communications. Each of the three example power measurements may represent a number of power measurements that may be made during the illustrated time periods.

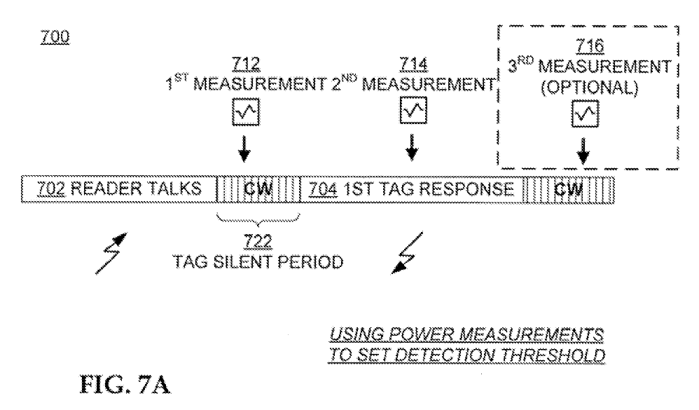

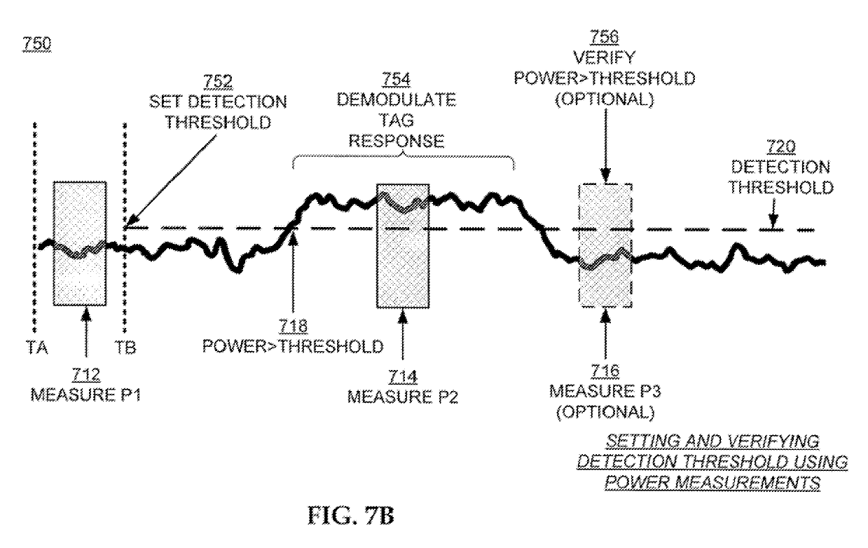

FIG. 7A is a diagram 700 illustrating use of power measurements in tag silent periods to set RFID tag detection threshold according to embodiments.

Diagram 700 shows the sequence of reader-tag communication that includes a period when the reader talks (702) followed by tag silent period 722, when the reader is still transmitting an unmodulated carrier wave (CW) to provide power to the passive tags. The silent period 722 is followed by the first tag response 704, which is proceeded by another silent period with the reader transmitting CW.

First measurement 712 can be made at any point during tag silent period 722 to set the detection threshold. According to some embodiments, first measurement 712 may comprise multiple measurements and the results averaged to set the detection threshold.

Second measurement 714 may be made at any time during the tag response 704. However, due to practical considerations such as variations in tag backscatter times, the second measurement is made preferably between time periods TC and TD shown in FIG. 6B. Similar to the first measurement, second measurement 714 may also comprise multiple measurements that are processed to determine an average and so on.

Diagram 700 also shows an optional third measurement 716, which may be made during after the tag response is over to verify the detection threshold or another purpose as will be discussed later. The optional third measurement 716 may be made during a second silent period as determined by worst case start times and backscatter durations for the tags.

FIG. 7B is another diagram 750 illustrating use of power measurements in tag silent periods to set and optionally verify RFID tag detection threshold according to embodiments.

Diagram 750 shown an example signal detected by a reader before, during, and after a tag response. The detected signal is at a relatively low level at the beginning when tag is silent. Measurement P1 (712) is made between time points TA and TB and detection threshold 720 is set at TB based on the measurement P1 (712).

Measurement P2 (714) is made during the tag response when the received power exceeds detection threshold 720. The tag response may exceed the detection threshold at point 718, but the measurement may detect the response later. Upon determination of the received power exceeding the detection threshold, the received signal may be demodulated as indicated by reference numeral 754.

An optional third measurement 756 may be made after the received signal drops below the detection threshold to re-determine and verify the detection threshold.

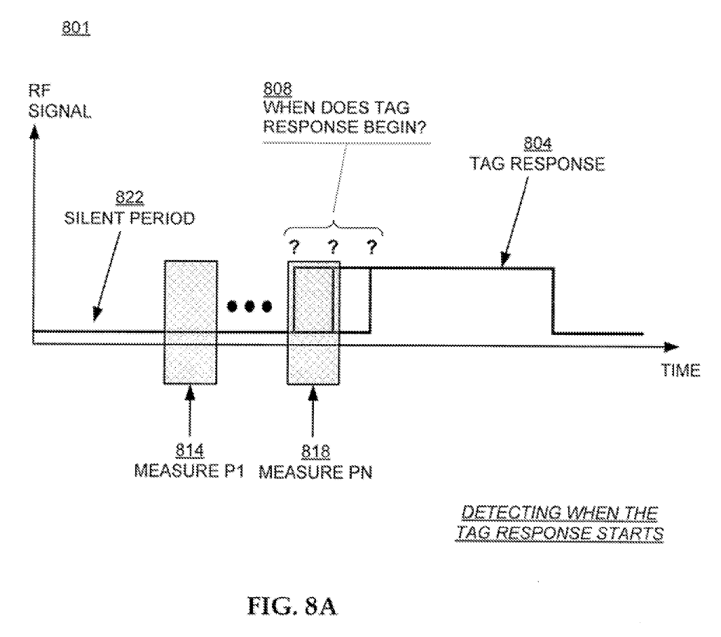

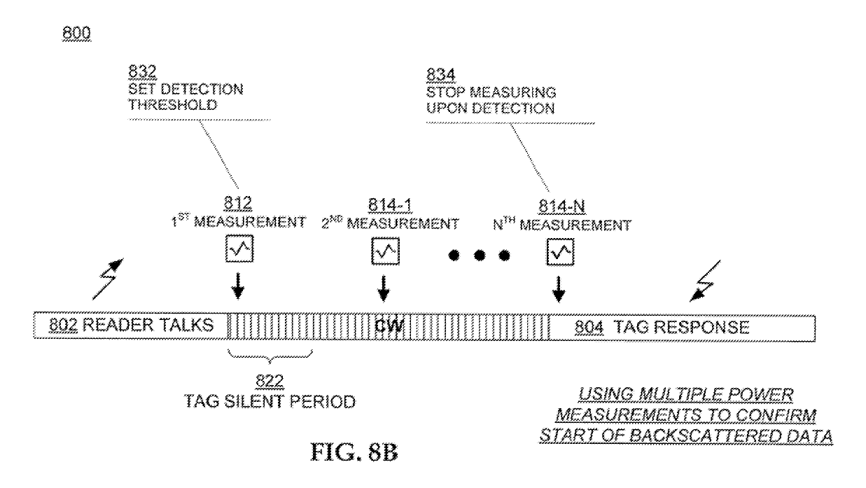

FIG. 8A is a diagram 801 illustrating how a start of a tag response may be detected using multiple power measurements according to embodiments.

In diagram 801, the RF signal received by the reader is represented by a straight line at low level in the silent period 822 and at high level during tag response 804 for simplicity purposes. Measurement P1 (814) is performed during the silent period. Another measurement may be performed (not shown) before P1 to set the detection threshold or P1 may be used to set the detection threshold. A question to be answered is when does the tag response begin (808)? As discussed previously, a single measurement may detect the tag response, but it may detect the response at any point during the response and not necessarily at the beginning of the response.

Differently from the embodiments described above, measurement P1 is followed by a number of additional measurements until measurement PN (818), where the tag response is detected fro the first time. Thus, a beginning of the tag response may be detected timely allowing demodulation of the tag response in one try.

FIG. 8B is another diagram 800 illustrating use of multiple power measurements to confirm start of backscattered data according to embodiments.

Diagram 800 shows the sequence of reader-tag communication similar to FIG. 7A, where a period when the reader talks (802) is followed by tag silent period 822 with the reader still transmitting an unmodulated carrier wave (CW) to provide power to the passive tags. The silent period 822 is followed by the tag response 804.

First measurement 812 can be made at any point during tag silent period 822, though preferably early, to set the detection threshold (832). According to some embodiments, first measurement 812 is followed by a series of measurements 814-l through 814-N, which are used to detect a beginning of the tag response.

As soon as one of the series of measurements detects received signal exceeding the detection threshold (e.g. N^{th} measurement 814-N), the beginning of the tag response is determined and measurements can be stopped (834). In addition, a demodulation action can be that the signal received thereafter is demodulated and accepted, while the signals received before the onset of the tag response can be discarded. These can even be first stored, as raw data or even demodulated data, until the decision to discard them or accept them.

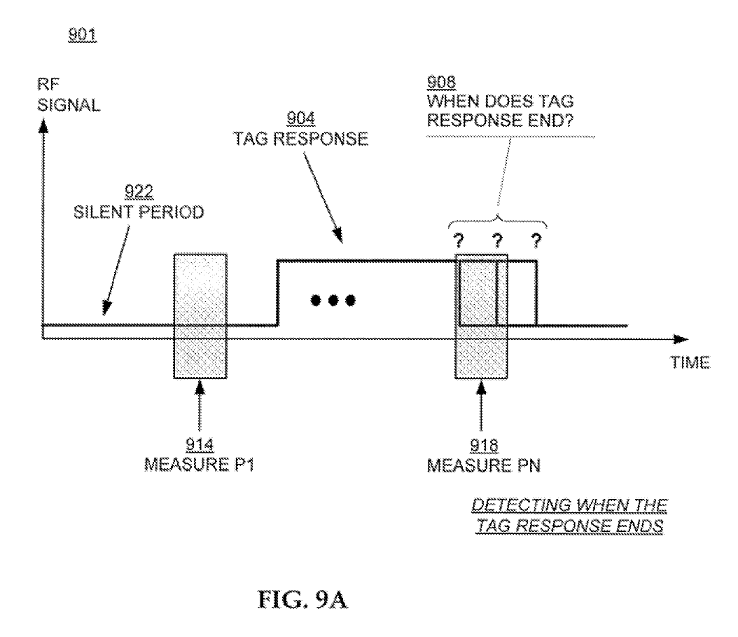

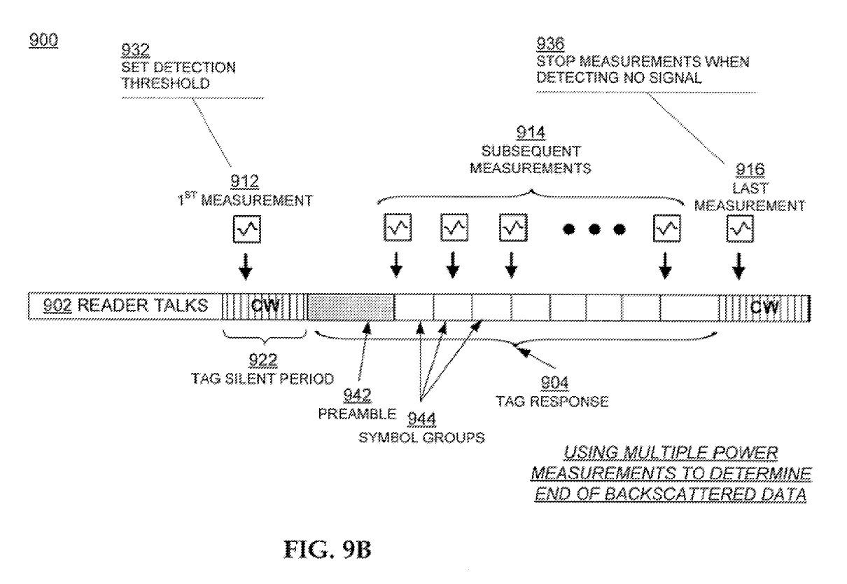

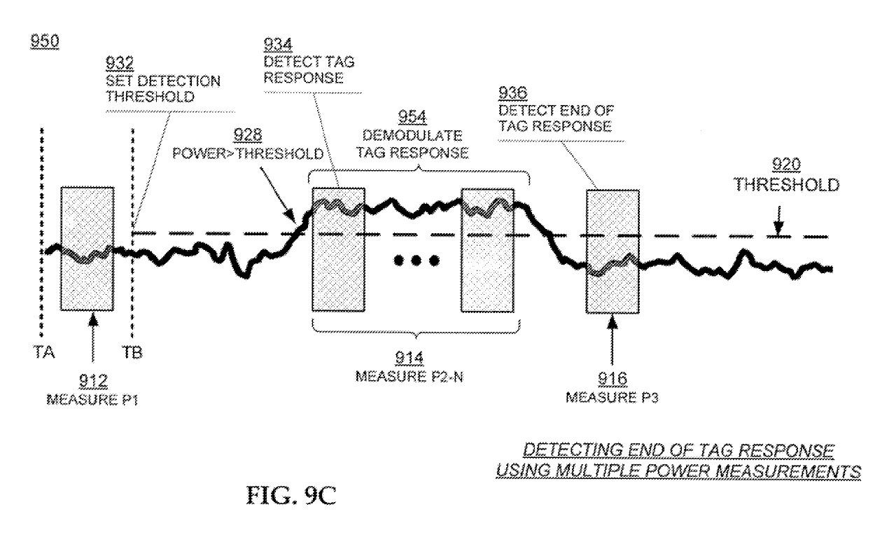

FIG. 9A is a diagram 901 illustrating how an end of a tag response may be detected using multiple power measurements according to embodiments.

In diagram 901, the RF signal received by the reader is represented by a straight line at low level in the silent period 922 and at high level during tag response 904 dropping to low level when the tag response ends. Measurement P1 (914) is performed during the silent period to set the detection threshold. A question to be answered is when does the tag response end (908)? For the same reasons discussed above in conjunction with FIG. 8A, a single measurement may detect the tag response but not necessarily at an end of the response.

According to some embodiments, measurement P1 is followed by a number of measurements PN (918) during the tag response. By using multiple measurements during the tag response the end of the response (when the received signal drops below the detection threshold again) may be detected accurately.

FIG. 9B is another diagram 900 illustrating use of multiple power measurements to confirm the end of backscattered data according to embodiments.

Diagram 900 shows the sequence of reader-tag communication similar to FIG. 9A, where a period when the reader talks (902) is followed by tag silent period 922 with the reader still transmitting an unmodulated carrier wave (CW) to provide power to the passive tags. The silent period 922 is followed by the tag response 904. Tag response 904 is shown in more detail in FIG. 9B with its components: preamble 942 and symbol groups 944. The tag response is followed by another silent period that includes CW transmission from the reader.

First measurement 912 can be made at any point during tag silent period 922 to set the detection threshold (932). A series of subsequent measurements 914 are used to detect the tag response. The measurements do not stop however upon detection of the tag response. They continue until the second silent period is detected by the last measurement 916. Then measurement can stop (936). In addition, a demodulation action can be that the signal received thereafter is discarded, and preferably no longer demodulated in the first place.

By employing multiple measurements during the tag response, not only can the end of the tag response be detected accurately, but also a number of symbol groups or a length of the data in the tag response may also be determined. For example, the first measurement may begin demodulation of the tag response and the preamble may be detected. A number of subsequent measurements until the last measurement detecting the end may provide information for determining the number of symbol groups in the response.

FIG. 9C is a further diagram 950 illustrating use of multiple power measurements to confirm the end of backscattered data according to embodiments.

Diagram 950 shows an example signal detected by a reader before, during, and after a tag response. The detected signal is at a relatively low level at the beginning when tag is silent. Measurement P1 (912) is made between time points TA and TB and detection threshold 920 is set at TB based on the measurement P1 (912).

Subsequent measurements P2-N (914) are made during the tag response when the received power exceeds detection threshold 920. The tag response may exceed the detection threshold at point 918, but the measurements may detect the response with a first one of measurements 914 (P2-l). Upon determination of the received power exceeding the detection threshold, the received signal may be demodulated as indicated by reference numeral 954.

When the tag response ends and the signal drops below the threshold 920 again, measurement P3 (916) detects the end of tag response. By making the measurement P3 (916) a part of the closely spaced measurements during the tag response, the end of the tag response may be detected accurately.

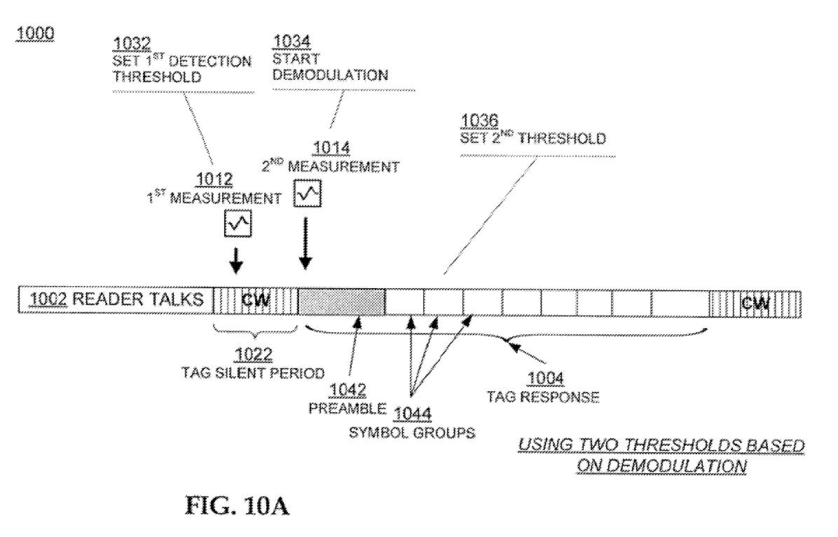

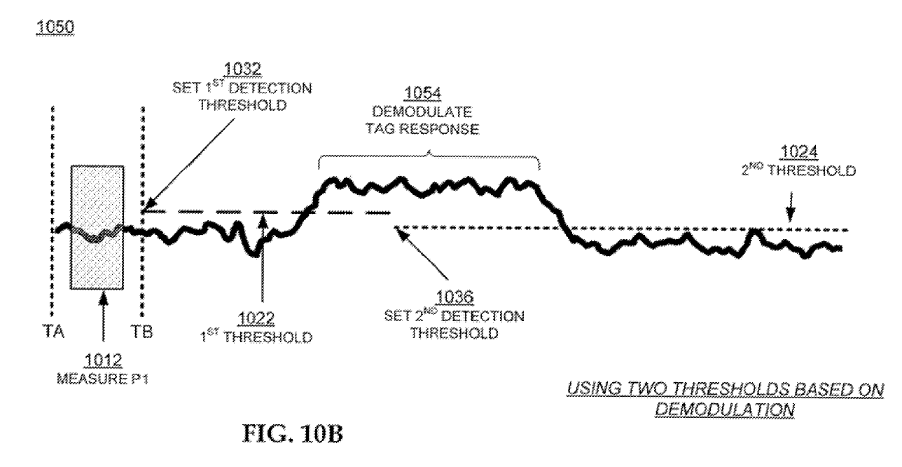

FIG. 10A is a diagram 1000 illustrating use of two thresholds based on demodulation according to embodiments.

Similar to diagram 900 of FIG. 9B, diagram 1000 shows the sequence of reader-tag communication, where a period when the reader talks (1002) is followed by tag silent period 1022 with the reader still transmitting an unmodulated carrier wave (CW) to provide power to the passive tags. The silent period 1022 is followed by the tag response 1004 with its components: preamble 1042 and symbol groups 1044. The tag response is followed by another silent period that includes CW transmission from the reader.

First measurement 1012 can be made at any point during tag silent period 1022 to set the detection threshold (1032). Second measurement 1014 detects the tag response and causes demodulation of the tag response to begin in the reader. Once the demodulation begins, a second threshold that is lower than the first detection threshold may be set (1036).

During the initial detection of tag response, the reader may need to be more selective since the environment may include noise from a number of interference sources. Once the tag response is detected, however, the reader the responding tag's frequency and may determine other parameters associated with the tag response such as the response's potential length. Another phenomenon that may typically occur during tag-reader communication is a drop in tag power as its responds. Thus, the reader may lower its detection threshold once it begins demodulating and allow the communication to be completed even with lower tag power.

FIG. 10B is another diagram 1050 illustrating use of two thresholds in detecting tag response based on demodulation according to embodiments.

Diagram 1050 shows an example signal detected by a reader before, during, and after a tag response. Similar to diagram 950 of FIG. 9C, the detected signal is at a relatively low level at the beginning when tag is silent. Measurement P1 (1012) is made between time points TA and TB and first detection threshold 1022 is set at TB based on the measurement P1 (1032).

Based on the first threshold 1022, the tag response is detected and demodulated (1054). Once demodulation begins, second threshold 1024 is set (1036) and continued communication with the tag is performed using the second detection threshold. Upon the end of the tag signal, the detection threshold can be reset to its previous value.

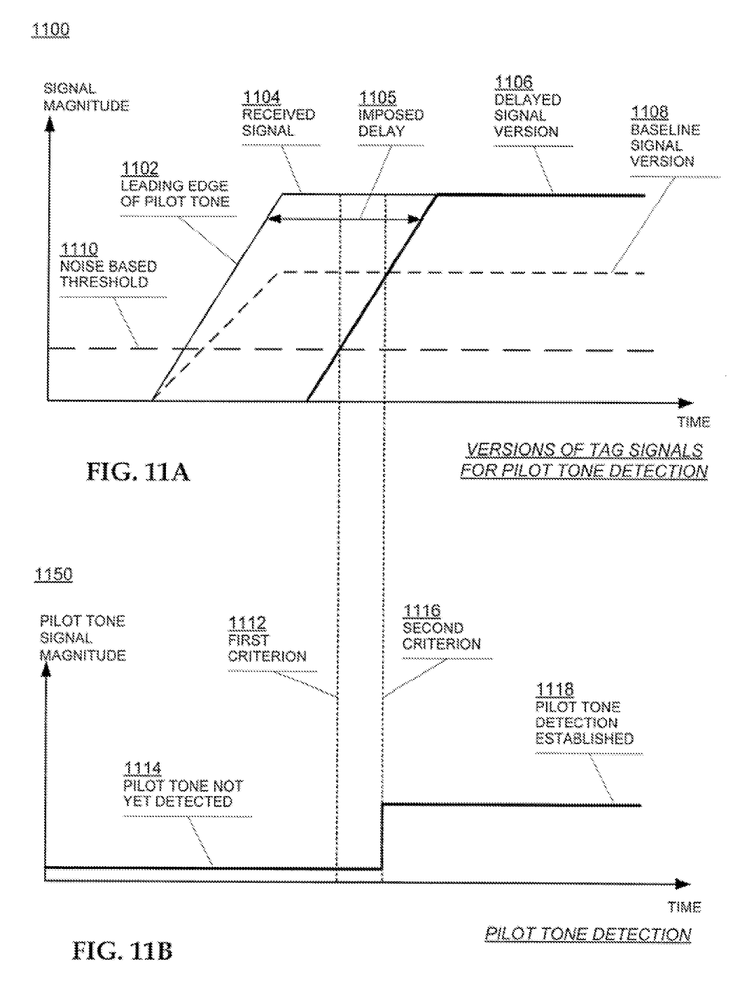

FIG. 11A illustrates waveforms representing versions of tag signals in detecting a tag pilot tone using a noise-based threshold.

A pilot tone transmitted by the tag for providing the reader with information about its response frequency and so on may be detected by the reader employing two separate criteria. A first criterion may include detection based on a comparison of the pilot tone with a noise-based threshold (1110) as shown in diagram 1100.

The noise-based threshold is set in response to a measurement performed at time point TI before the tag response is expected. The measurement may be a power measurement and the power estimate scaled to set a desired False Alarm Rate (FAR) and a detection probability. Since the threshold is based on an actual measurement, it adapts to a dynamic RFID environment, which may include interference noise, different tag power levels, and so on.

Once the first detection occurs, an auto-normalized threshold 1108 may be set based on the signal magnitude. The threshold may be peak-held and scaled. A delayed signal version (1106) may also be derived from the received signal (1104) by imposing a preset delay 1105. A leading edge of the received pilot tone 1102 increases with the same gradient as the delayed version.

The delayed version 1106 is then compared to the signal-based threshold 1108 to detect the pilot tone with an accurate time of arrival estimate.

FIG. 11B illustrates detection of a tag pilot tone using two criteria according to embodiments.

Diagram 1150 shows pilot tone magnitude over time. Initially the pilot tone is not detected (1114). The first criterion 1112 (noise-based threshold) initiates the implementation of the second criterion 1116 (signal-based threshold). If both are satisfied, pilot tone detection is established (1118).

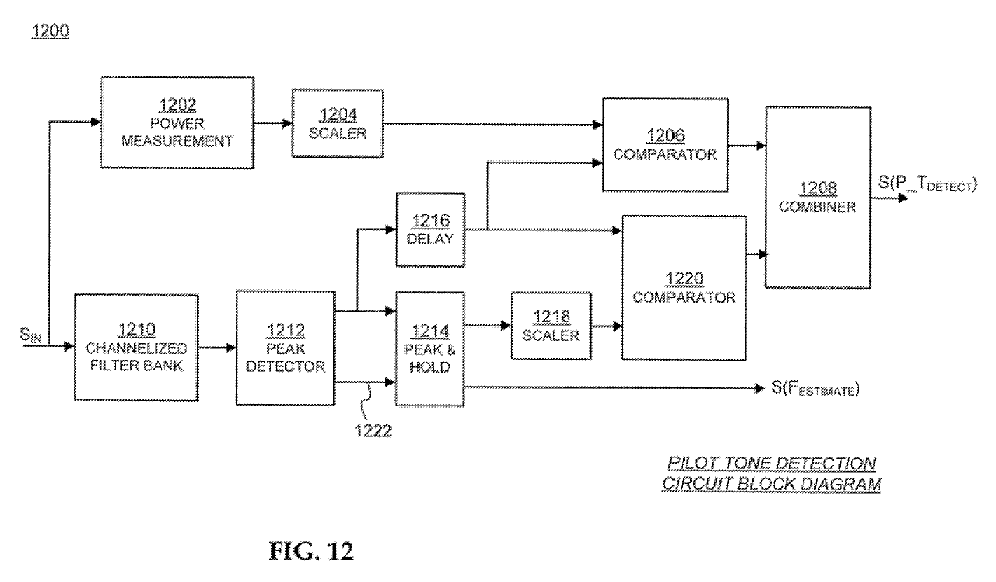

FIG. 12 is a block diagram for an embodiment of a pilot tone detection circuit where the waveforms of FIG. 11A may be observed.

Circuit 1200 includes a channelized filter bank 1210 which receives the incoming signal, divides into a spectrum, and provides to peak detector 1212. The received signal S_{IN} is also provided to power measurement block 1202. The measured power is scaled by scaler 1204 and provided to comparator 1206.

A delayed version of the detected peak of the filtered input signal S_{IN} is provided by delay block 1216 to comparators 1206 and 1220. A peak and hold block 1214 receives the detected peaks of the filtered input signal providing an input to scaler 1218 as well as a frequency estimate output.

An output of scaler 1218 is provided to comparator 1220 for comparison with the delayed version of the signal. Both comparator outputs are then combined at combiner 1208 to provide the pilot tone detection signal S(P_T_{Detect}).

The waveforms and circuits described above illustrate an example embodiment for using threshold(s) in tag response detection. Other circuits and waveforms may also be used without departing from a scope and spirit of the invention.

In this description, numerous details have been set forth in order to provide a thorough understanding. In other instances, well-known features have not been described in detail in order to not obscure unnecessarily the description.

A person skilled in the art will be able to practice the embodiments in view of this description, which is to be taken as a whole. The specific embodiments as disclosed and illustrated herein are not to be considered in a limiting sense. Indeed, it should be readily apparent to those skilled in the art that what is described herein may be modified in numerous ways. Such ways can include equivalents to what is described herein.

The following claims define certain combinations and sub-combinations of elements, features, steps, and/or functions, which are regarded as novel and non-obvious. Additional claims for other combinations and sub-combinations may be presented in this or a related document.

What is claimed is:

1. A method for a Radio Frequency Identification (RFID) reader system to communicate with a plurality of RFID tags, comprising:
causing a first signal to be transmitted from the RFID reader system, the first signal causing the RFID tags to be silent during a first tag silent period;
measuring an aspect of an initial reference signal received during the first tag silent period;
receiving a second signal;
comparing a power of the second signal with the detection threshold; and
performing a demodulation action on the second signal depending on the comparison.

2. The method of claim 1, in which
the aspect is one of power, voltage and current.

3. The method of claim 1, in which
the aspect is measured from a plurality of measurements.

4. The method of claim 1, further comprising:
adjusting a data rate of a transmit circuit of the RFID system, if the measured aspect exceeds a threshold.

5. The method of claim 1, further comprising:
commanding the RFID tags to not respond on a baseband frequency of the first signal, but on its subcarrier, if the measured aspect exceeds a threshold.

6. The method of claim 1, in which
the detection threshold is determined as a quantity expressed in one of: dB, Watts, Volts, Amps, and a number.

7. The method of claim 1, in which
the detection threshold is set by adjusting a filter in a receive circuit of the RFID reader system.

8. The method of claim 1, in which
the first signal further causes at least one of the RFID tags to start responding within a known response window, and
the second signal is received within the known response window.

9. The method of claim 1, in which
the power of the second signal is determined from a plurality of measurements.

10. The method of claim 1, in which
the second signal power is greater than the detection threshold, and
the demodulation action includes starting demodulating the second signal.

11. The method of claim 1, in which
the second signal is stored,
the second signal power is greater than the detection threshold, and
the demodulation action includes demodulating and start accepting the stored second signal.

12. The method of claim 1, in which
the second signal power is greater than the detection threshold,
third signals are received prior to the second signal being received, the third signals having a power less than the detection threshold, and
the third signals are discarded.

13. The method of claim 1, in which
the second signal power is greater than the detection threshold,
the demodulation action includes demodulating the second signal, and further comprising:
setting the detection threshold to an updated value corresponding to receiving tag data;
receiving third signals after the second signal; and
rejecting the third signals if a power of the third signals becomes less than the detection threshold with the updated value.

14. The method of claim 13, further comprising:
then resetting the detection threshold to its previous value.

15. The method of claim 1, in which
the second signal power is greater than the detection threshold,
a third signal is caused to be transmitted from the RFID system, the third signal causing the RFID tags to be silent during a second tag silent period;
an aspect of a second reference signal received during the second tag silent period is measured; and
the demodulation action includes discarding the second signal if a power of the second reference signal is greater than the detection threshold.

16. The method of claim 1, in which
the second signal power is not greater than the detection threshold, and
the demodulation action includes discarding or starting discarding the second signal, instead of demodulating and accepting it.

17. The method of claim 16, further comprising:
storing the second signal prior to discarding it.

18. The method of claim 16, further comprising:
demodulating the second signal prior to discarding it.

19. The method of claim 16, in which
third signals are received prior to the second signal being received, the third signals having a power greater than the detection threshold; and
the third signals are demodulated and accepted.

20. The method of claim 19, in which
the third signals are portions of a response from one of the RFID tags, and
a duration of the tag response is determined based on the timing of the second signal.

21. The method of claim 20, further comprising:
measuring a power of the third signals according to a timing of the portions.

22. The method of claim 20, further comprising:
decoding the tag response;
determining an expected length of the tag response from the expected length; and
if the determined duration is inconsistent with the expected duration, discarding the tag response.

23. An article comprising a machine-readable memory containing thereon instructions which, if executed by a component of a Radio Frequency Identification (RFID) reader system, cause the component to perform operations comprising:
causing a first signal to be transmitted from the RFID reader system, the first signal causing the RFID tags to be silent during a first tag silent period;
measuring an aspect of an initial reference signal received during the first tag silent period;
setting a detection threshold from the measured aspect of the initial reference signal;
receiving a second signal;
comparing a power of the second signal with the detection threshold; and
performing a demodulation action on the second signal depending on the comparison.

24. The article of claim 23, in which
the aspect is one of power, voltage and current.

25. The article of claim 23, in which
the aspect is measured from a plurality of measurements.

26. The article of claim 23, the operations further comprising:
adjusting a data rate of a transmit circuit of the RFID system, if the measured aspect exceeds a threshold.

27. The article of claim 23, the operations further comprising:
commanding the RFID tags to not respond on a baseband frequency of the first signal, but on its subcarrier, if the measured aspect exceeds a threshold.

28. The article of claim 23, in which
the detection threshold is determined as a quantity expressed in one of: db, Watts, Volts, Amps, and a number.

29. The article of claim 23, in which
the detection threshold is set by adjusting a filter in a receive circuit of the RFID reader system.

30. The article of claim 23, in which
the first signal further causes at least one of the RFID tags to start responding within a known response window, and
the second signal is received within the known response window.

31. The article of claim 23, in which
the power of the second signal is determined from a plurality of measurements.

32. The article of claim 23, in which
the second signal power is greater than the detection threshold, and
the demodulation action includes starting demodulating the second signal.

33. The article of claim 23, in which
the second signal is stored,
the second signal power is greater than the detection threshold, and
the demodulation action includes demodulating and start accepting the stored second signal.

34. The article of claim 23, in which
the second signal power is greater than the detection threshold,
third signals are received prior to the second signal being received, the third signals having a power less than the detection threshold, and
the third signals are discarded.

35. The article of claim 23, in which
the second signal power is greater than the detection threshold,
the demodulation action includes demodulating the second signal,
and the operations further comprising:
setting the detection threshold to an updated value corresponding to receiving tag data;
receiving third signals after the second signal; and
rejecting the third signals if a power of the third signals becomes less than the detection threshold with the updated value.

36. The article of claim 35, the operations further comprising:
then resetting the detection threshold to its previous value.

37. The article of claim 23, in which
the second signal power is greater than the detection threshold,
a third signal is caused to be transmitted from the RFID system, the third signal causing the RFID tags to be silent during a second tag silent period;
an aspect of a second reference signal received during the second tag silent period is measured; and
the demodulation action includes discarding the second signal if a power of the second reference signal is greater than the detection threshold.

38. The article of claim 23, in which
the second signal power is not greater than the detection threshold, and
the demodulation action includes discarding or starting discarding the second signal, instead of demodulating and accepting it.

39. The article of claim 38, the operations further comprising:
storing the second signal prior to discarding it.

40. The article of claim 38, the operations further comprising:
demodulating the second signal prior to discarding it.

41. The article of claim 38, in which
third signals are received prior to the second signal being received, the third signals having a power greater than the detection threshold; and
the third signals are demodulated and accepted.

42. The article of claim 41, in which
the third signals are portions of a response from one of the RFID tags, and
a duration of the tag response is determined based on the timing of the second signal.

43. The article of claim 42, the operations further comprising:
measuring a power of the third signals according to a timing of the portions.

44. The article of claim 42, the operations further comprising:
decoding the tag response;
determining an expected length of the tag response from the decoded tag response;
determining an expected duration of the tag response from the expected length; and
if the determined duration is inconsistent with the expected duration, discarding the tag response.

45. An operational processing block for a Radio Frequency Identification (RFID) reader system to communicate with one or more RFID tags, the block operable to:
cause a first signal to be transmitted from the RFID reader system, the first signal causing the RFID tags to be silent during a first tag silent period;
measure an aspect of an initial reference signal received during the first tag silent period;
set a detection threshold from the measured aspect of the initial reference signal;
receive a second signal;
compare a power of the second signal with the detection threshold; and
perform a demodulation action on the second signal depending on the comparison.

46. The operational processing block of claim 45, in which
the aspect is one of power, voltage and current.

47. The operational processing block of claim 45, in which
the aspect is measured from a plurality of measurements.

48. The operational processing block of claim 45, further operable to:
adjust a data rate of a transmit circuit of the RFID system, if the measured aspect exceeds a threshold.

49. The operational processing block of claim 45, further operable to:
command the RFID tags to not respond on a baseband frequency of the first signal, but on its subcarrier, if the measured aspect exceeds a threshold.

50. The operational processing block of claim 45, in which
the detection threshold is determined as a quantity expressed in one of: dB, Watts, Volts, Amps, and a number.

51. The operational processing block of claim 45, in which
the detection threshold is set by adjusting a filter in a receive circuit of the RFID reader system.

52. The operational processing block of claim 45, in which
the first signal further causes at least one of the RFID tags to start responding within a known response window, and
the second signal is received within the known response window.

53. The operational processing block of claim 45, in which
the power of the second signal is determined from a plurality of measurements.

54. The operational processing block of claim 45, in which
the second signal power is greater than the detection threshold, and
the demodulation action includes starting demodulating the second signal.

55. The operational processing block of claim 45, in which
the second signal is stored,
the second signal power is greater than the detection threshold, and
the demodulation action includes demodulating and start accepting the stored second signal.

56. The operational processing block of claim 45, in which
the second signal power is greater than the detection threshold,
third signals are received prior to the second signal being received, the third signals having a power less than the detection threshold, and
the third signals are discarded.

57. The operational processing block of claim 45, in which
the second signal power is greater than the detection threshold,
the demodulation action includes demodulating the second signal,
and the block is further operable to:
set the detection threshold to an updated value corresponding to receiving tag data;
receive third signals after the second signal; and
reject the third signals if a power of the third signals becomes less than the detection threshold with the updated value.

58. The operational processing block of claim 57, further operable to:
then reset the detection threshold to its previous value.

59. The operational processing block of claim 45, in which
the second signal power is greater than the detection threshold,
a third signal is caused to be transmitted from the RFID system, the third signal causing the RFID tags to be silent during a second tag silent period;
an aspect of a second reference signal received during the second tag silent period is measured; and
the demodulation action includes discarding the second signal if a power of the second reference signal is greater than the detection threshold.

60. The operational processing block of claim 45, in which
the second signal power is not greater than the detection threshold, and
the demodulation action includes discarding or starting discarding the second signal, instead of demodulating and accepting it.

61. The operational processing block of claim 60, further operable to:
store the second signal prior to discarding it.

62. The operational processing block of claim 60, further operable to:
demodulate the second signal prior to discarding it.

63. The operational processing block of claim 60, in which
third signals are received prior to the second signal being received, the third signals having a power greater than the detection threshold; and
the third signals are demodulated and accepted.

64. The operational processing block of claim 63, in which
the third signals are portions of a response from one of the RFID tags, and
a duration of the tag response is determined based on the timing of the second signal.

65. The operational processing block of claim 64, further operable to:
measure a power of the third signals according to a timing of the portions.

66. The operational processing block of claim 64, further operable to:
decode the tag response;
determine an expected length of the tag response from the decoded tag response;
determine an expected duration of the tag response from the expected length; and
if the determined duration is inconsistent with the expected duration, discard the tag response.
